(19) United States
(12) Patent Application Publication
(10) Pub. No.: US 2007/0253067 A1
(43) Pub. Date: Nov. 1, 2007

(54) Imaging system and method employing illumination field de-focus at the illumination modulator

(76) Inventors: Stephen F. Sagan, Lexington, MA (US); David B. Larsen, Woburn, MA (US)

Correspondence Address: AGFA CORPORATION;PATENT DEPARTMENT, 200 BALLARDVALE STREET, WILMINGTON, MA, 01887, US

(21) Appl. No.: 11/413,644

(22) Filed: Apr. 28, 2006

(51) Int. Cl. G02B 27/10

(52) U.S. Cl. 359/618

(57) ABSTRACT

An imaging system and method are disclosed which includes a high power illumination source for providing a first illumination field at the surface of an illumination modulator, the illumination field is defocused at the surface of the illumination modulator reducing the power density at the illumination modulator. Subsequent to the illumination modulator an anamorphic optical element(s) is provided to refocus the illumination field at an image surface coincident with the focus of the illumination modulator at that image surface.

### BACKGROUND OF THE INVENTION

The invention generally relates to imaging systems, and relates in particular to imaging systems that employ an illumination modulator.

Conventional imaging systems for transferring an image to a printing plate typically include an illumination system for generating a field of illumination, and an optical assembly for applying the field of illumination in a modulated form to an imaging surface. Such illumination systems may provide a line of laser illumination so that a line of picture elements (or pixels) may be imaged at a time for efficiency in imaging. The field of illumination may be modulated by selectively controlling the illumination system as disclosed in U.S. Pat. No. 4,804,975 herein incorporated by reference in its entirety for background information only. Modulation can also occur by using a light modulator for selectively modulating the field of illumination.

Illumination systems that modulate the illumination field generally require that relatively high powers be switched on and off at fairly high speeds. In the field of pre-press imaging which is directed toward transferring an image via a laser source to a printing plate, the power requirements vary depending on the particular printing plate or medium which is being used. For thermal imaging onto a thermal printing plate, very high power is necessary to either ablate the material on the medium or chemical alter the medium layers by thermal reaction. The power necessary of the laser sources can range as high as 100 watts of energy. The total power dissipated on optical elements of an imaging head can be in the order of 100 watts of total power, or a concentrated focused energy as high as 12 kw/cm². Other systems, for example those that use violet printing plates require the lower energy of an ultra-violet light source.

The use of high power lasers for imaging can be expensive and difficult to use to achieve high quality and/or high resolution imaging. It is desirable, therefore, that light modulators be used in certain applications to permit the illumination system to provide a relatively uniform field of illumination. This allows the laser emitters to exhibit relatively uniform power consumption and be maintained at a relatively uniform temperature, which also contributes to uniformity of the illumination field.

Imaging systems such as those disclosed in U.S. Pat. No. 6,433,934, herein incorporated by reference in its entirety for background information only, may include an illumination source, a field lens system, an illumination modulator, imaging optics and an imaging surface. During imaging, the field lens system directs the illumination field onto the light modulator and the light modulator reflects the illumination field toward the imaging surface in one mode and reflects the illumination field away from the imaging surface in another mode. The modulator may, for example, include a Grating Light Valve (GLV™) as sold by Silicon Light Machines of Sunnyvale, Calif., and the system may direct, via the imaging optics, either the zero order reflection or the first order reflection toward the imaging surface in various embodiments.

Illumination modulators are often limited to the total amount of optical power incident on the modulator as well as the power density impinging on the device. Exceeding these limits can lead to poor performance or actual destruction of the device. For example, the GLV modulator has movable ribbons constructed of silicon nitride over-coated with aluminum for reflectivity. Applying excessive optical power will soften the ribbons and change the response characteristics of the device. Additionally, applying too much localized power from, for example, a tightly focused spot or illumination line can reach a power density of many kilowatts per square centimeter. This can cause the aluminum to be evaporated from the ribbons destroying the device.

### SUMMARY OF THE INVENTION

It is an object of the invention to provide an imaging system and an imaging method including a method and apparatus to defocus the illumination field at the illumination modulator and to refocus the illumination field at the image surface thereby reducing the optical power density impinging on the illumination modulator.

It is another object of this invention to provide an imaging system and an imaging method including a method and apparatus to remove the astigmatism between the illumination field and the image of the modulator at the image surface.

It is a further object of this invention to provide a method and apparatus to create a specific spot size at the imaging surface by modifying the anamorphic expansion factor of the refocusing device.

### BRIEF DESCRIPTION OF THE DRAWINGS

The following description may be further understood with reference to the accompanying drawings in which:

FIG. 1 shows an illustrative diagrammatic view of the preferred embodiment of the invention with the illumination field defocused on the illumination modulator;

FIG. 2 shows an illustrative diagrammatic view another embodiment of the invention with the illumination field focused on the illumination modulator;

FIG. 2A is a top view of an anamorphic group with alternate positions.

FIG. 3A is a side view optical diagram of a prior art embodiment of an imaging head;

FIG. 3B is a top view optical diagram of the illumination system plus the grating light valve of the imaging head of FIG. 3A;

FIG. 3C is a top view optical diagram of the imaging system of the imaging head of FIG. 3A;

FIG. 3D is a diagram of a preferred aperture of elliptical shape for use in the imaging head of FIG. 3A; and

FIG. 4 is a perspective view of an image medium positioned for imaging on an external drum and recorded upon by the imaging head of FIG. 3A;

### DETAILED DESCRIPTION OF THE PREFERRED EMBODIMENTS

A preferred embodiment of the invention is directed towards solving the problem of allowing the use of one or more higher powered laser sources for maximizing imaging power, while simultaneously allowing the optical elements of the imaging optics in the imaging head to function properly, without deforming or burning up optical elements, particularly the modulator, within the imaging head.

The above-identified and other problem in the prior art are solved by a method for transferring an image via an illumination system including a modulator to an image plane on a medium, where the method includes the steps of:
(1) generating a substantially uniform line of radiation from one or more illumination modules;
(2) impinging the uniform line of radiation onto an illumination modulator;
(3) lessening an intensity of the line of radiation on the illumination modulator by providing an astigmatism so that the line of radiation is out of focus on the modulator, wherein a maximum defocus of an illumination field is constrained by a predetermined numerical aperture of the illumination system and by a predetermined operating dimension of the illumination modulator;
(4) modulating said defocused line of radiation via said illumination modulator to generate a line of modulated radiation;
(5) adjusting the line of modulated radiation to eliminate the astigmatism at the image plane using an anamorphic lens;
(6) adjusting image magnification of the line of modulated radiation onto the medium at the image plane; and
(7) adjusting image focus of the line of radiation onto the medium at the image plane.

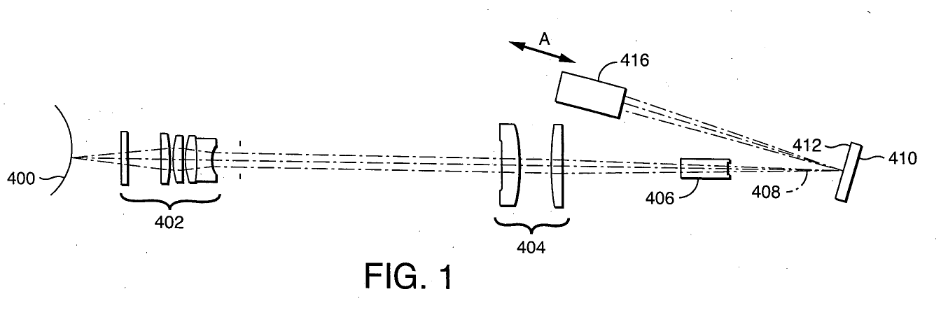

Turning to the preferred embodiment of FIG. 1, an illumination module 416 houses the laser source(s), a modulator 410 for reflectively diffracting and modulating radiation received from the source 416, a first lens group or element 406, a second lens group 404, a third lens group 402 and a medium 400 supported on an outside surface of an external drum imaging system.

In the preferred method a substantially uniform line of radiation is generated in the illumination module(s) 416 typically containing one or more laser sources. The laser beams emitted from the illumination module 416 are received and reflected from a surface 412 of the GLV modulator 410. The laser source 416 is translatable for example along in a linear direction A so that a first focus or an object plane focus of the line of radiation is offset and positioned for example at 408 away from the surface of the GLV modulator. This astigmatism is also defined as having the line of radiation to be out of focus on the GLV modulator. In this way, the concentration of energy or intensity of the line of radiation per square unit on the GLV surface is lessened than if the object plane focus was located directly on the plane of the GLV. By doing so, the GLV can withstand greater dispersed radiation or energy from the source 416 without causing damage or malfunction to the GLV modulator.

The first anamorphic lens group or lens element 406 is an anamorphic element which operates transmit and realign the de-focused light received from the modulator 410. The second lens group 404 is used to adjust image magnification of the line of modulated radiation onto the medium at the image plane. Third lens group 402 adjusts the image focus of the line of radiation onto the medium at the image plane which is coincident with the surface of the medium 400.

Systems of the invention may be used in a variety of imaging systems such as, for example, thermal imaging systems that include an illumination field, an illumination modulator and an imaging surface (e.g., an external imaging drum). The modulator receives the illumination field via a field lens system and directs a modulated illumination field toward the imaging surface or medium via imaging optics. The illumination source, field lens system, modulator, imaging optics and imaging surface may be as disclosed in U.S. Pat. No. 6,433,934, herein incorporated by reference in its entirety for background information only. The modulator may include a Grating Light Valve (GLV) as sold by Silicon Light Machines of Sunnyvale, Calif.

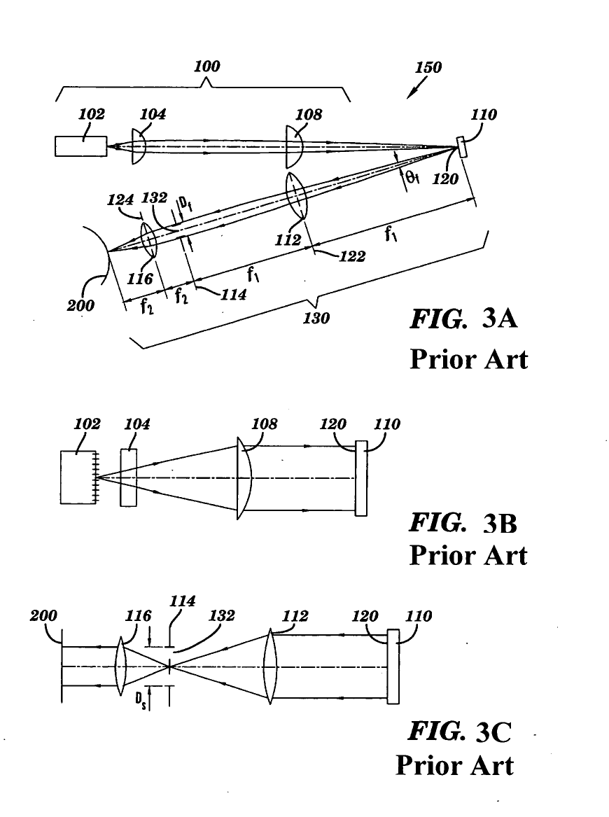

FIGS. 3A, 3B and 3C illustrate side and top views of a prior art structure and operation of an optical imaging head 150 which can be separated into two basic parts, the illumination system 100 and the imaging system 130. The illumination system 100 generates and emits a line of continuous wave energy. The zero order diffractive imaging system 130 receives the continuous wave energy or radiation at the object plane 120 of the GLV 110, then transfers an image via zero order diffractive radiation through various components to an imaging medium.

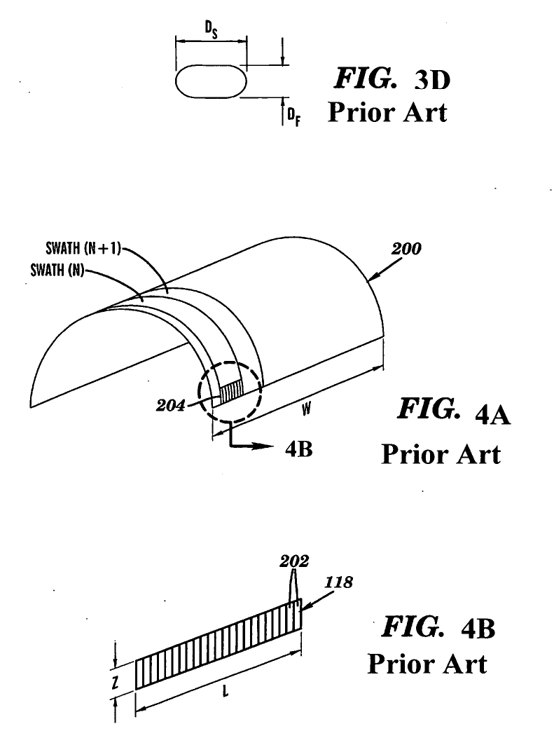

In FIG. 3A, the illumination system 100 takes the form of a line illumination module 100 which includes a bar 102 of laser diodes for generating multiple laser beams, a fast axis collimating lens 104 for evenly dispersing the radiation in a fast axis direction and a slow axis collimating lens 108 for evenly dispersing the radiation in a slow axis direction. The laser bar 102 is a group of laser diodes which emit laser beams to the fast axis collimating lens 104. The slow axis direction corresponds to the movement of the optical head along the longitudinal axis of an imaging drum which parallels the linear direction along the width W (see FIG. 4A) of the image plane or medium 200, whereas the fast axis direction corresponds to the tracking of a laser beam along the radial direction of the drum, e.g. along a swath (N) of the medium 200.

The type of light source used is dependent upon the particular media. In the preferred embodiment, the medium 200 is thermally sensitive, so an appropriate laser light source is used for imaging on that media. However, other sources of electromagnetic energy could be used, as necessary, for various applications.

The medium 200, shown in FIG. 4A, is positioned as supported on an external drum (not shown). A line of illumination 118 (also referred to as a line of radiation), which is coincident with the medium 200 at the image plane, has a length L and a width Z. Each line of illumination 118 contains a predetermined number of sections 202 which, respectively, correspond to some number of pixels on the GLV 110. The line of illumination 118 is imaged at an initial position 204 along a first swath (N) on the sheet of medium 200. As the drum rotates, pixels along the line of illumination 118 are turned ON or OFF according to image information supplied by control electronics as well known in the art. Modulation of pixels is synchronized to the rotational speed of the drum. This procedure continues until imaging is complete on swath (N). The movement of the line of illumination 118 from swath (N) to (N+1) is facilitated by movement of the imaging head along the longitudinal axis (i.e. the slow axis) of the rotating drum. Then, the above-described imaging procedure is repeated for swath (N+1) and all additional swaths until the image is completely transferred onto the medium 200. The imaging procedure could also be accomplished by other means such as a spiral scan of the media as well known in the art.

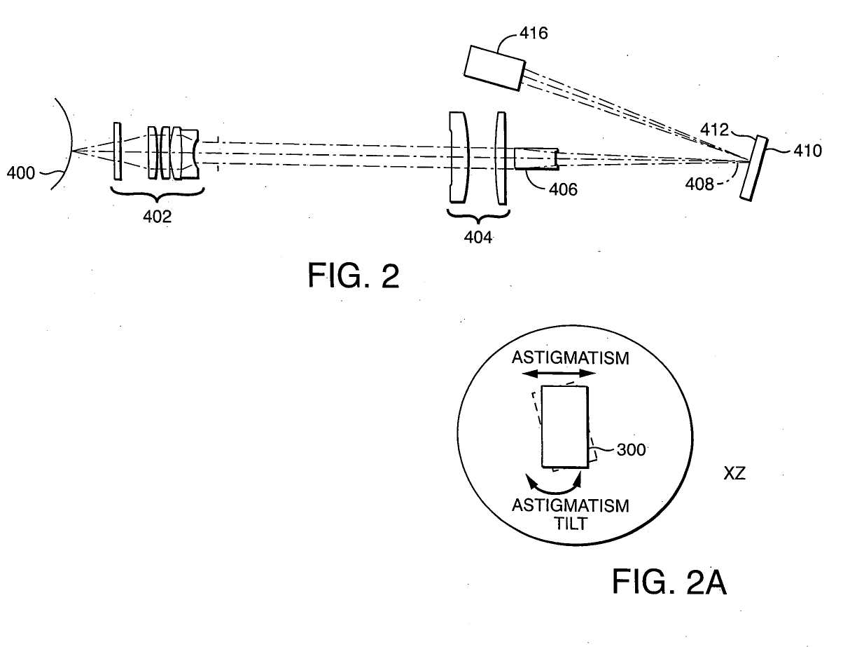

FIG. 2 illustrates a structure which includes an anamorphic group 406. The focus 408 of the illumination field is shown coincident with the object plane 412 of the GLV 410. The anamorphic group 406 is positioned so as to cause the focus of the illumination line or fast axis (FA) focus to be coincident with the medium 400. Magnification elements 404 (second lens group) and focusing elements 402 (third lens group) of the imaging system relay the image of the GLV 410 to a slow axis (SA) focus at the medium 400.

FIG. 2A illustrates alternate positioning of the anamorphic group 406 which allows for all points of the fast axis focus to be aligned to be coplanar with the medium 400. Rotation of the anamorphic group 406 eliminates astigmatic tilt and translation of the anamorphic group 406 eliminates astigmatism. The astigmatism being the non coplanarity between the fast axis illumination field image and the slow axis illumination modulator image.

The preferred embodiment of the invention shown in FIG. 1 illustrates the focus 408 of the illumination field being offset from the object plane 412 of the GLV 410 by an amount sufficient to cause the desired defocus of the illumination field on the GLV 410 thereby causing a broader fast axis spot to be incident on the GLV 410 reducing the peak power density of the illumination field on the GLV 410. The anamorphic group 406 is shown positioned to cause the fast axis focus of the illumination field to be coincident with the slow axis focus of the image of the GLV 410 and the medium 400.

1. A method for transferring an image via an illumination system including a modulator to an image plane on a medium, the method comprising the steps of:
generating a substantially uniform line of radiation from one or more illumination modules;
impinging the uniform line of radiation onto an illumination modulator;
lessening an intensity of the line of radiation on the illumination modulator by providing an astigmatism so that the line of radiation is out of focus on the modulator, wherein a maximum defocus of an illumination field is constrained by a predetermined numerical aperture of the illumination system and by a predetermined operating dimension of the illumination modulator;
modulating said defocused line of radiation via said illumination modulator to generate a line of modulated radiation;
adjusting the line of modulated radiation to eliminate the astigmatism at the image plane using an anamorphic lens;
adjusting image magnification of the line of modulated radiation onto the medium at the image plane; and
adjusting image focus of the line of radiation onto the medium at the image plane.

2. An imaging system for transferring an image to a medium, said system comprising;
one or more illumination sources for generating one or more substantially uniform lines of radiation;
a modulator which receives the radiation from the one or more illumination sources and provides a modulated line of radiation to an image plane at the medium, wherein said one or more illumination sources are intentionally positioned to cause the one or more lines of radiation to be out of focus on the modulator resulting in an astigmatism;
an anamorphic lens which receives the modulated line of radiation and which compensates and corrects the astigmatism; and
lenses for adjusting image magnification and image focus of the line of modulated radiation onto the medium at the image plane.
